(19) United States
(12) Patent Application Publication
(10) Pub. No.: US 2005/0028842 A1
(43) Pub. Date: Feb. 10, 2005

(54) Method of cleaning a substrate and an apparatus thereof

(75) Inventors: Tae-Hyun Kim, Gyeonggi-Do (KR); Kyung-Hyun Kim, Seoul-City (KR); Byoung-Moon Yoon, Gyeonggi-Do (KR); In-Seak Hwang, Gyeonggi-Do (KR)

Correspondence Address: MARGER JOHNSON & McCOLLOM, P.C., 1030 S.W. Morrison Street, Portland, OR, 97205, US

(73) Assignee: Samsung Electronics Co., Ltd.

(21) Appl. No.: 10/882,008

(22) Filed: Jun. 29, 2004

(30) Foreign Application Priority Data
Aug. 5, 2003 (KR) 2003-54209

(51) Int. Cl. B08B 3/00

(52) U.S. Cl. 134/31; 134/32; 134/34; 134/137; 134/142

(57) ABSTRACT

In one embodiment, an apparatus includes a cleaning bath for containing a cleaning solution, one or more substrate holders configured to support the substrate in the cleaning solution, means for removing the substrate from the cleaning solution, and means for releasing the one or more substrate holders from the substrate while the one or more substrate holders are immersed in the cleaning solution. Therefore, the formation of water spots or chemical stains on a substrate can be prevented.

This application claims the priority of Korean Patent Application No. 2003-54209, filed on Aug. 5, 2003 in the Korean Intellectual Property Office, the disclosure of which is incorporated herein in its entirety by reference.

### BACKGROUND OF THE INVENTION

1. Field of the Invention

The present invention relates to apparatus and method for manufacturing semiconductor devices and, more particularly, to apparatus and method for cleaning a substrate.

2. Description of Related Art

In general, semiconductor substrates are cleaned, before and after fabrication processes such as diffusion, photolithography, and deposition processes are performed. During the cleaning process, impurities generated during the fabrication processes can be removed.

Typically, the impurities remaining on the substrates are removed in a cleaning bath filled with a cleaning solution. The substrates are then rinsed with deionized water (DIW) and dried. After these processes, the substrates are lifted from the cleaning bath.

However, water spots or chemical stains may be formed where substrate holders hold the substrates due to the cleaning solution that remains between the substrate and the substrate holders. For example, water spots may be formed on a substrate made of a silicon material shortly after washing in DIW, because DIW dissolves the silicon substrate.

Such water spots or chemical stains are detrimental to semiconductor fabrication, because they can cause defects by forming an unwanted oxide layer and particles on the substrates. These particles may migrate to the inner portion of the substrates, thereby degrading the device characteristics or causing device failures. As a result, the yield can be significantly decreased.

Accordingly, there is an immediate need for an apparatus and method of cleaning a semiconductor substrate without forming such water spots or chemical stains.

### SUMMARY OF THE INVENTION

In one embodiment, an apparatus includes a cleaning bath for containing a cleaning solution, one or more substrate holders configured to support the substrate in the cleaning solution, means for removing the substrate from the cleaning solution, and means for releasing the one or more substrate holders from the substrate while the one or more substrate holders are immersed in the cleaning solution.

In another embodiment, a method of drying a substrate includes immersing a substrate in a cleaning solution; supporting the substrate, using one or more substrate holders; partially removing the substrate from the cleaning solution; and releasing the one or more substrate holders from the substrate while the one or more substrate holders are immersed in the cleaning solution.

### BRIEF DESCRIPTION OF THE DRAWINGS

Other features and advantages of the present invention will be more readily understood from the following detailed description of specific embodiments thereof when read in conjunction with the accompanying drawings, in which:

FIGS. 1A-1D are schematic views for sequentially illustrating a substrate cleaning method in accordance with one embodiment of the present invention;

FIGS. 2A-2D are schematic diagrams of examples of substrate holders used to implement the embodiments of the present invention;

FIGS. 3A-3D are schematic views for sequentially illustrating a substrate cleaning method in accordance with another embodiment of the present invention;

FIGS. 4A-4D are schematic views for sequentially illustrating a substrate cleaning method in accordance with yet another embodiment of the present invention; and

FIGS. 5A-5D are schematic views for sequentially illustrating a substrate cleaning method in accordance with still another embodiment of the present invention.

### DETAILED DESCRIPTION OF THE PREFERRED EMBODIMENTS

The preferred embodiments of the present invention will now be described more fully hereinafter with reference to the accompanying drawings. The present invention may, however, be embodied in different forms and should not be construed as limited to the embodiments set forth herein. Rather, these embodiments are provided to more fully convey the scope of the invention. Like numbers in the drawings refer to like elements throughout the specification.

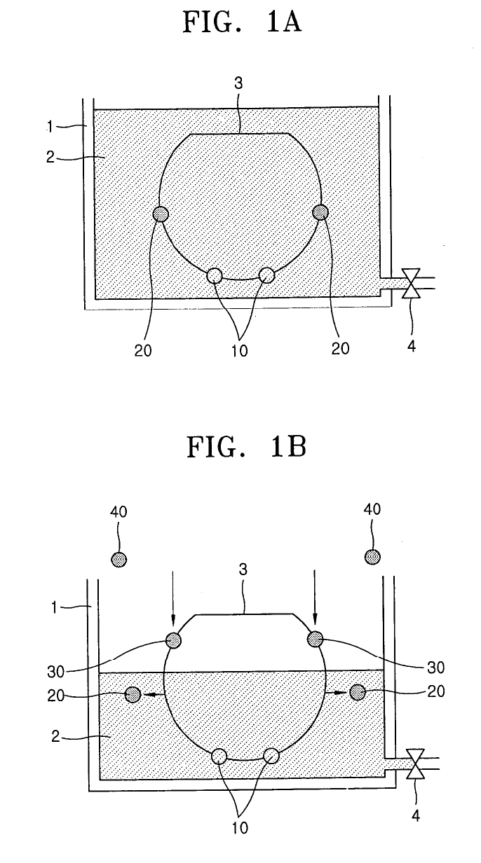

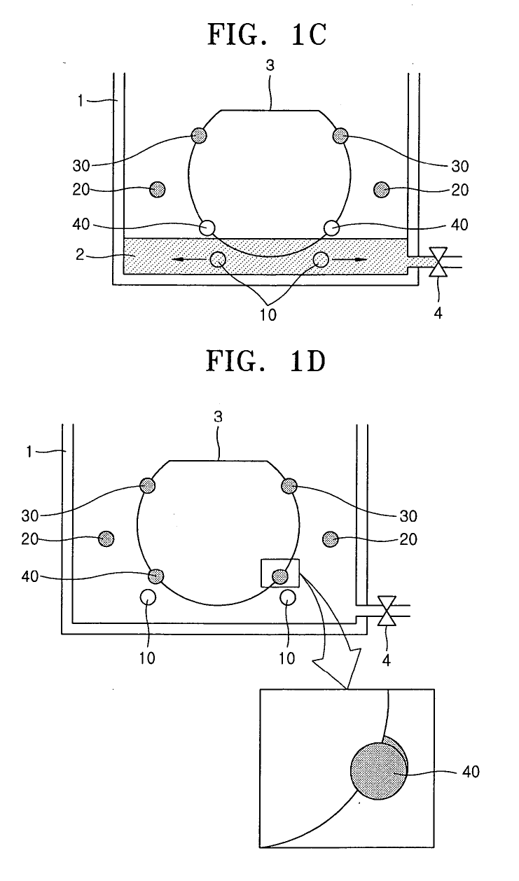

Referring to FIG. 1A, according to an embodiment of the present invention, a substrate or wafer 3 is immersed in a cleaning solution 2, preferably in a cleaning tub 1. The substrate 3 may be any substrate used for forming various microelectronic devices such as a semiconductor memory device, microprocessor, MEMS (Micro Electro Mechanical system), opto-electronic device, display device. Thus, the substrate may be a silicon substrate, SOI (silicon on insulator), Ga-As substrate, Si-Ge substrate, ceramic substrate, quartz substrate, or glass substrate for a display device.

As described above, during the cleaning process, impurities generated during the previous processes can be removed or the substrate is pre-conditioned for the next process steps. The cleaning solution 2 may be a chemical solution such as a liquid including HF or a standard cleaning solution including NH₄OH, H₂O₂ and H₂O by the ratio of approximately 1:4:20 (such as SC-1) or DIW (or pure water). The substrate 3 may be held or supported by a first substrate holder 10, a second substrate holder 20, or both in the cleaning solution 2.

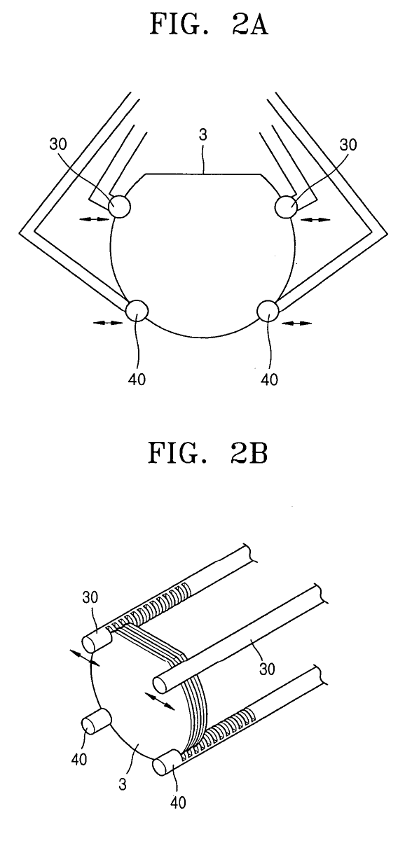

One example of such substrate holders is shown in FIG. 2A. Holders 30 or 40 shown in FIG. 2A are structured to hold a single substrate. Alternatively, the holders 30, 40 can be configured to hold a plurality of substrates as shown in FIG. 2B.

Referring to FIG. 1B, the substrate 3 immersed in the cleaning solution 2 is preferably partially removed from the cleaning solution 2 to expose an upper portion of the substrate 3. An exposed portion of the substrate 3 may be held or supported using the third substrate holder 30.

The second substrate holder 20 is released from the substrate 3 while it is immersed in the cleaning solution 2.

According to one aspect, to partially remove the substrate 3, the cleaning solution 2 may be drained through a drain valve 4. One example of such drain valve is discussed in U.S. Pat. No. 6,598,312, the contents of which are incorporated herein by reference.

Referring to FIG. 1C, as the substrate 3 is further removed from the cleaning solution 2, the substrate 3 may be optionally held by a fourth substrate holder between the first substrate holder 10 and the third substrate holder 30. Then, if the first substrate holder 10 were used to support the substrate 3, the first substrate holder 10 would be released from the substrate 3, while it is still immersed in the cleaning solution 2.

Referring to FIG. 1D, the substrate 3 is preferably completely removed from the cleaning solution 2. With the concepts of the present invention, no water spots or chemical stains are formed on the substrate 3, where the substrate holders 10 and/or 20 hold the substrate 3, as indicated by FIG. 1D.

In contrast, in the prior art, water spots or chemical stains could form where the substrate holders hold the substrates due to the chemical solution or water that remains between the substrate and the substrate holders. Particularly, the water spots or chemical stains could form, as the water or chemical solution that remains between the substrate and the substrate holders are exposed to a surrounding atmosphere during the removal of the substrate from the cleaning solution. More particularly, when the contact area where the substrate holder holds the substrate passes through an interface between the cleaning solution and a surrounding atmosphere, residues of the cleaning solution can be left on the contact area where the substrate holder holds the substrate. This is believed to result from interactions between the adhesive power of the water (or chemical solution residue) and the adhesion between the water and the substrate holder (and/or the adhesion between the water and the substrate).

However, with the novel methods of the present invention, the first and/or second substrate holders 10, 20, for example, are preferably released from the substrate 3 while they are still immersed in the cleaning solution 2 or before the substrate 3 is exposed to the surrounding atmosphere.

As a result, no water spots or chemical stains will be formed, even when the contact area between the substrate 3 and the substrate holder is exposed to the surrounding atmosphere, or when it passes through the interface between the cleaning solution and the atmosphere. Because the holders do not contact the substrate, during removal of the substrate 3 from the cleaning solution, no chemical solution residue or water can be retained between the substrate 3 and the substrate holders. Water spots or chemical stains can therefore be prevented.

Preferably, the surrounding atmosphere comprises a vapor. More preferably, the vapor comprises nitrogen, IPA, air, or combinations thereof.

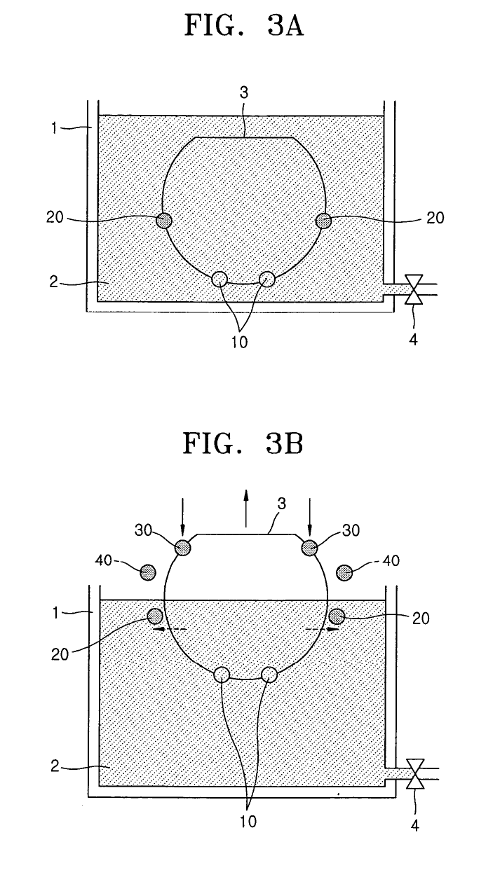

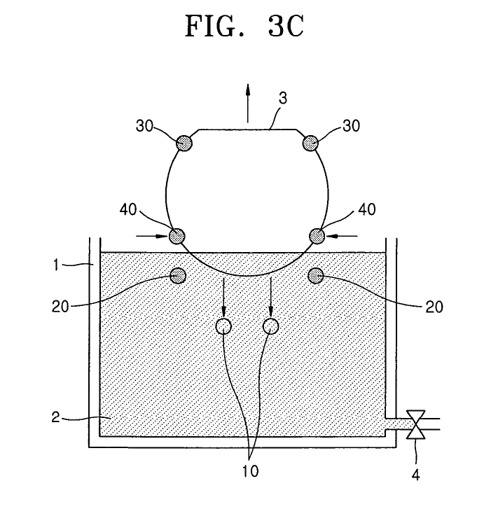

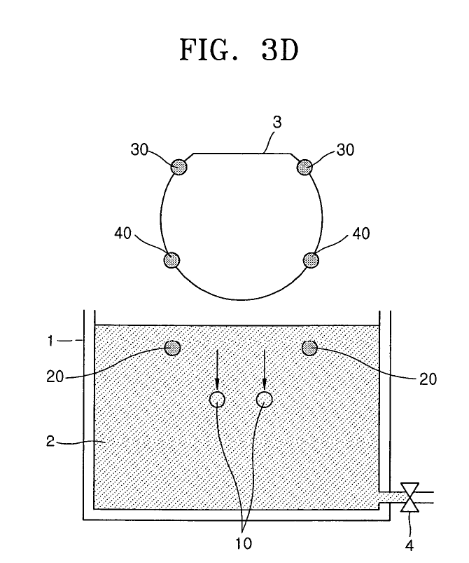

FIG. 3A illustrates another embodiment of the present invention. In detail, a substrate or wafer 3 is immersed in a cleaning solution 2, preferably in a cleaning tub 1.

Referring To FIG. 3B, the substrate 3 immersed in the cleaning solution 2 is preferably partially removed from the cleaning solution 2 to expose an upper portion of the substrate 3. An exposed portion of the substrate 3 may be held and/or supported by the third substrate holder 30.

The second substrate holder 20 is preferably released from the substrate 3 while it is immersed in the cleaning solution 2, or before the substrate 3 is exposed to the surrounding atmosphere. The first substrate holder 10 may preferably support the substrate 3 during this process.

According to one aspect, the substrate 3 is preferably lifted from the cleaning tub 1, to partially remove the substrate 3 from the cleaning solution 2, using conventional lifting devices such as those described in U.S. Pat. Nos. 4,722,752 and 6,533,872, for example, the contents of which are incorporated by reference in their entirety.

Referring to FIG. 3C, as the substrate 3 is further lifted from the cleaning solution 2, the substrate 3 may optionally be held or supported by a fourth substrate holder 40 between the first substrate holder 10 and the third substrate holder 30. Then, if the first substrate holder 10 were used to support the substrate 3, the first substrate holder 10 would be released from the substrate 3, while it is still immersed in the cleaning solution 2. In FIG. 3C, the first substrate holder 10 is lowered to release from the substrate 3.

Referring to FIG. 3D, the substrate 3 is then preferably completely removed from the cleaning solution 2. For the reasons discussed above, no water spots or chemical stains are formed on the substrate 3, after the cleaning or drying process thereafter.

Thus, the embodiment disclosed in FIGS. 3A-3D is similar to the embodiment illustrated in FIGS. 1A-1D except that the substrate 3 is lifted from the cleaning tub 1 to partially remove the substrate 3 from the cleaning solution 2, using conventional lifting devices.

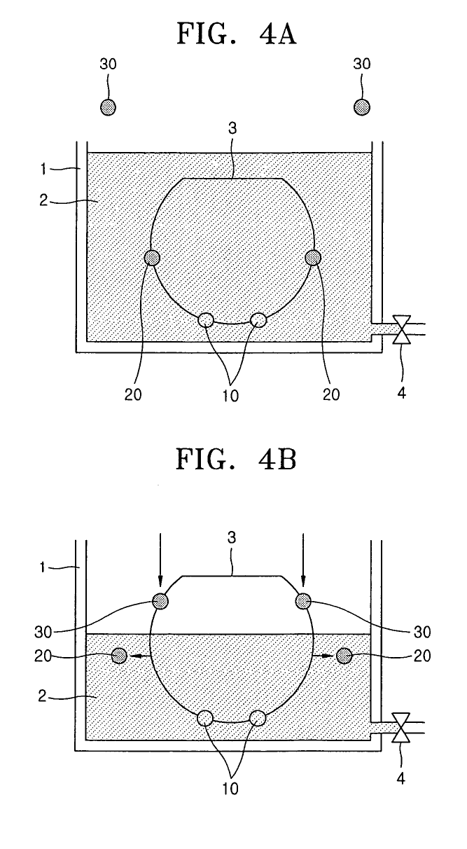

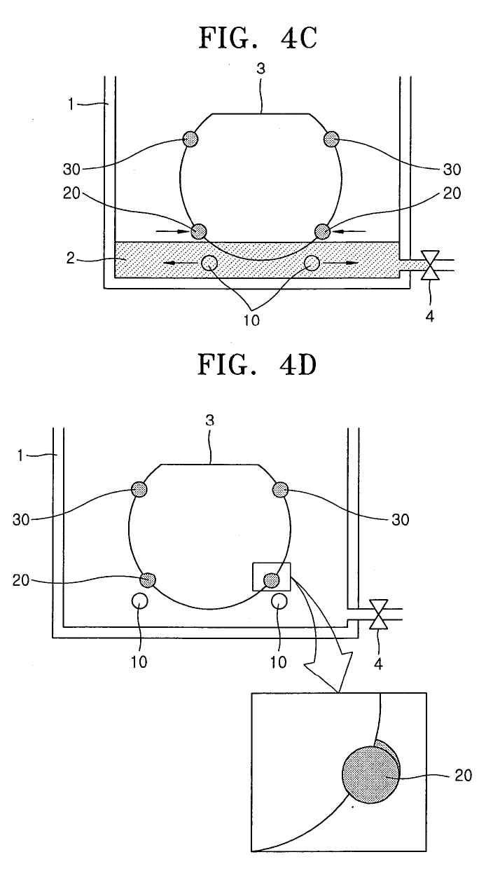

Referring to FIG. 4A, according to still another embodiment of the present invention, a substrate or wafer 3 is immersed in a cleaning solution 2, preferably in a cleaning tub 1, and is supported by a second substrate holder 20 and a first substrate holder 10.

Referring to FIG. 4B, the substrate 3 immersed in the cleaning solution 2 is preferably partially removed from the cleaning solution 2 to expose an upper portion of the substrate 3. An exposed portion of the substrate 3 may be held and/or supported by a third substrate holder 30.

The second substrate holder 20 is released from the substrate 3 while it is immersed in the cleaning solution 2. The first substrate holder 10 supports the substrate 3 during this process.

Referring to FIG. 4C, the previously-released second substrate holder 20 hold or grab the substrate 3 again as illustrated before the first substrate holder 10 is released from the substrate 3, while the first substrate holder 10 is immerse in the cleaning solution 2.

Referring to FIG. 4D, the substrate 3 is then preferably completely removed from the cleaning solution 2.

Alternatively, although not shown in drawings, the substrate 3 may be cleaned using a method similar to the method described in connection with FIGS. 4A-4D except that the substrate 3 is removed from the cleaning solution 2 using a lifting device similar to the device used in the method in connection with FIG. 3B.

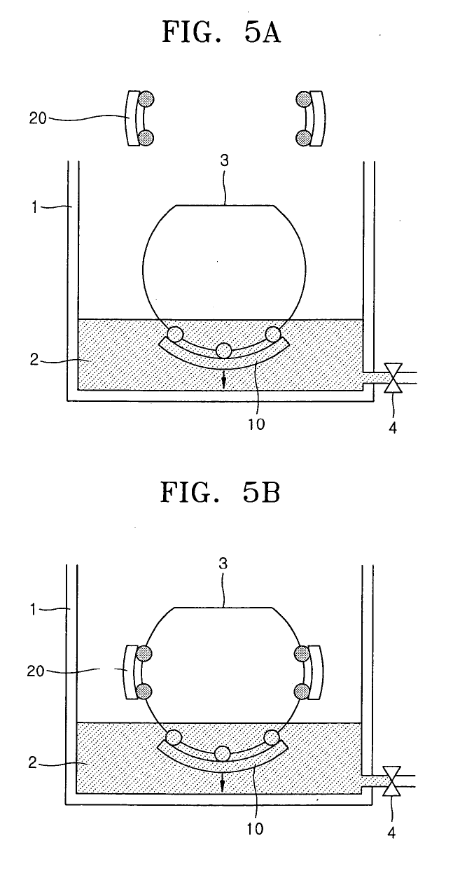

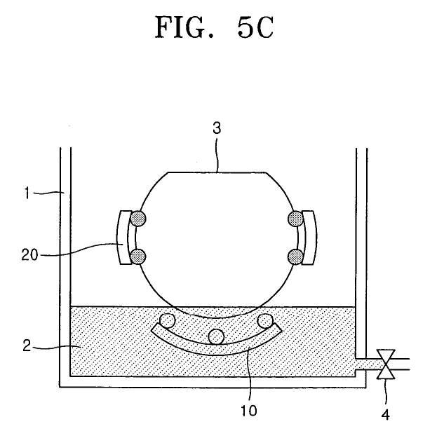

Referring to FIGS. 5A-5B, according to still another embodiment, two sets of substrate holders can be used to implement the principles of the present invention, rather than three or four sets of substrate holders, as in the previous embodiments.

More particularly, referring to FIG. 5A, a first substrate holder 10 supports a substrate 3 immersed in a cleaning solution 2.

Referring to FIG. 5B, as in the above-described embodiments, the substrate 3 immersed in the cleaning solution 2 is partially removed from the cleaning solution 2 to expose an upper portion of the substrate 3. An exposed portion of the substrate 3 is then preferably held using a second substrate holder 20.

Referring to FIG. 5C, the first substrate holder 20 is preferably released from the substrate 3 while it is immersed in the cleaning solution 2.

Then, the substrate 3 is then preferably completely removed from the cleaning solution 2. (not shown) Alternatively, although not explicitly represented in drawings, the substrate 3 may be cleaned using a method similar to the method described in connection with FIGS. 5A-5D except that the substrate 3 is removed from the cleaning solution 2 using a lifting device similar to the device used in the method described in connection with FIG. 3B.

Therefore, to implement the methods of the present invention described above, one skilled in the art will appreciate that an apparatus may include a cleaning bath or container for containing a cleaning solution, one or more substrate holders configured to support the substrate in the cleaning solution, means for partially removing the substrate from the cleaning solution, and means for releasing the one or more substrate holders from the substrate while the one or more substrate holders are immersed in the cleaning solution.

The means for partially removing the substrate from the cleaning solution may be a drain valve or a lifting device as described above. Also, one skilled in the art will appreciate that the means for releasing the first substrate holder may be any device including a controller that can release one or more substrate holders from the substrate while the one or more substrate holders are immersed in the cleaning solution or before the substrate is exposed to a surrounding atmosphere.

According to another embodiment, an apparatus for performing the above-described process may comprise a first substrate holder for holding a substrate in a cleaning solution. The apparatus can further include means for partially removing the substrate from the cleaning solution to expose an upper portion of the substrate, a second substrate holder for holding the exposed portion of the substrate, and means for releasing the first substrate holder from the substrate while the first substrate holder is immersed in the cleaning solution.

Therefore, with the embodiments of the present invention described above, it is now possible to prevent the formation of water spots or chemical stains on a substrate because one or more substrate holders can be released from a substrate while they are still immersed in a cleaning solution or before the substrate is exposed to a surrounding atmosphere. During the removal of the substrate from the cleaning solution, there is therefore no chemical solution residue or water remaining between the substrate 3 and the substrate holders that can result in water spots or chemical stains.

The principles of the present invention can be applied to various substrate cleaning or drying methods including, but not limited to, a method utilizing a Marangoni effect, one example of which is disclosed in U.S. Pat. No. 6,430,840, the contents of which are incorporated herein by reference. Also, while the apparatus for implementing the above-described embodiments are schematically shown for simplicity, any other devices that are capable of implementing the concepts of the present invention can be used. For example, various numbers or shapes of substrate holders can be used to implement the various embodiments of the present invention.

Although the exemplary embodiments of the present invention have been described in detail, it should be understood that many variations and/or modifications of the basic inventive concepts herein will be apparent to those skilled in the art, and will still fall within the spirit and scope of the present invention as defined in the appended claims. For example, the first substrate holder may be released from the substrate by lowering the second substrate holder to hold the substrate, then raising the second substrate holder to release the first substrate holder from the substrate. Also, the first substrate holder may be released from the substrate by lowering the second substrate holder to hold the substrate, then lowering the first substrate holder to release the first substrate holder from the substrate. Any number of other combinations are also possible in keeping with the inventive principles disclosed herein.

1. A method for cleaning a substrate, comprising:
immersing a substrate in a cleaning solution;
supporting the substrate, using one or more substrate holders;
partially removing the substrate from the cleaning solution; and
releasing the one or more substrate holders from the substrate while the one or more substrate holders are immersed in the cleaning solution.

2. The method of claim 1, further comprising:
supporting the substrate using one or more substrate holders communicating with an exposed portion of the substrate; and
completely removing the substrate from the cleaning solution.

3. The method of claim 1, wherein the substrate is immersed in the cleaning solution in a cleaning tub, and wherein partially removing the substrate comprises lifting the substrate from the cleaning tub.

4. The method of claim 1, wherein the substrate is immersed in the cleaning solution in a cleaning tub, and wherein partially removing the substrate comprises draining the cleaning solution from the cleaning tub.

5. A method for cleaning a substrate, comprising:
immersing a substrate in a cleaning solution;
holding the substrate using a first substrate holder in the cleaning solution;
partially removing the substrate from the cleaning solution, thereby exposing an upper portion of the substrate;
holding the exposed portion of the substrate using a second substrate holder; and
releasing the first substrate holder from the substrate while the first substrate holder is immersed in the cleaning solution.

6. The method of claim 5, wherein the exposed portion of the substrate is held using the second substrate holder before the first substrate holder is released from the substrate.

7. The method of claim 5, wherein the substrate is immersed in the cleaning solution in a cleaning tub, and wherein partially removing the substrate comprises lifting the substrate from the cleaning tub.

8. The method of claim 5, wherein the substrate is immersed in the cleaning solution in a cleaning tub, and wherein partially removing the substrate comprises draining the cleaning solution from the cleaning tub.

9. A method for cleaning a substrate, comprising:
immersing a substrate in a cleaning solution;
holding the substrate, using a first substrate holder in the cleaning solution;
partially removing the substrate from the cleaning solution, thereby exposing an upper portion of the substrate;
holding an exposed portion of the substrate, using a second substrate holder; and
releasing the first substrate holder from the substrate before the first substrate holder is exposed to an ambient.

10. The method of claim 9, wherein the ambient comprises a vapor.

11. The method of claim 10, wherein the vapor comprises nitrogen, isopropyl alcohol (IPA), air, or combinations thereof.

12. The method of claim 9, wherein releasing the first substrate holder from the substrate comprises lowering the second substrate holder to hold the substrate, then raising the second substrate holder to release the first substrate holder from the substrate.

13. The method of claim 9, wherein releasing the first substrate holder from the substrate comprises lowering the second substrate holder to hold the substrate, then lowering the first substrate holder to release the first substrate holder from the substrate.

14. An apparatus for cleaning a substrate, comprising:
one or more substrate holders configured to support the substrate in a cleaning solution;
means for removing the substrate from the cleaning solution; and
means for releasing the one or more substrate holders from the substrate while the one r more substrate holders are immersed in the cleaning solution.

15. The apparatus of claim 14, wherein means for removing the substrate comprises a lifting device.

16. The apparatus of claim 14, wherein means for removing the substrate comprises a drain.

17. An apparatus comprising:
a first substrate holder for holding a substrate in a cleaning solution;
means for partially removing the substrate from the cleaning solution to expose an upper portion of the substrate;
a second substrate holder for holding the exposed portion of the substrate; and
means for releasing the first substrate holder from the substrate while it is immersed in the cleaning solution.

18. The apparatus of claim 17, further comprising a controller to release one or more substrate holders from the substrate while the one or more substrate holders are immersed in the cleaning solution or before the substrate is exposed to a surrounding atmosphere.

19. The apparatus of claim 17, further comprising a cleaning bath for containing the cleaning solution therein.

20. The apparatus of claim 17, wherein the means for partially removing the substrate comprises a lifting device.

21. The apparatus of claim 17, wherein the means for partially removing the substrate comprises a drain.

22. A method for cleaning a substrate, comprising:
immersing a substrate in a cleaning solution;
holding the substrate using at least one of first and second substrate holders in the cleaning solution;
partially removing the substrate from the cleaning solution, thereby exposing an upper portion of the substrate;
holding the exposed portion of the substrate using a third substrate holder; and
releasing the second substrate holder from the substrate while the second substrate holder is immersed in the cleaning solution;
holding another exposed portion of the substrate using the released second substrate holder, below the third substrate holder; and
releasing the first substrate holder from the substrate while the first substrate holder is immersed in the cleaning solution.

23 The method of claim 22, wherein the exposed portion of the substrate is held using the third substrate holder before the second substrate holder is released from the substrate.

24 The method of claim 22, wherein another exposed portion of the substrate is held using the second substrate holder before the first substrate holder is released from the substrate.

25. The method of claim 22, wherein the substrate is immersed in the cleaning solution in a cleaning tub, and wherein partially removing the substrate comprises lifting the substrate from the cleaning tub.

26. The method of claim 22, wherein the substrate is immersed in the cleaning solution in a cleaning tub, and wherein partially removing the substrate comprises draining the cleaning solution from the cleaning tub.
